(19) United States
(12) Patent Application Publication
(10) Pub. No.: US 2011/0313719 A1
(43) Pub. Date: Dec. 22, 2011

(54) BELT-TYPE CONTINUOUSLY VARIABLE TRANSMISSION

(75) Inventor: Kenichi Yamaguchi, Aichi-ken (JP)

(73) Assignee: Toyota Jidosha Kabushiki Kaisha, Toyota-shi (JP)

(21) Appl. No.: 13/254,671

(22) PCT Filed: Mar. 19, 2010
(86) PCT No.: PCT/JP10/54770

§ 371 Date: Sep. 2, 2011

(30) Foreign Application Priority Data
Apr. 17, 2009 (JP) 2009-100758

(51) Int. Cl. G06F 15/00

(52) U.S. Cl. 702/150

(57) ABSTRACT

A belt-type continuously variable transmission that is able, using a simple structure, to accommodate size reduction and to accurately determine an actual transmission ratio. A belt-type continuously variable transmission includes a measurement surface formed on an outer circumferential end of a movable sheave, and a displacement sensor provided isolatedly from the outer circumferential end for measuring the distance between the measurement surface and the displacement sensor. The measurement surface is formed such that the distance H between the measurement surface and the displacement sensor is changed as the movable sheave moves in the axial direction.

### TECHNICAL FIELD

The present invention relates to a belt-type continuously variable transmission, and in particular to improvement of a structure for determining a transmission ratio.

### BACKGROUND ART

As a transmission connected on the output side of a motor for driving a vehicle, a belt-type continuously variable transmission (a so-called “CVT”: Continuously Variable Transmission) has been conventionally known.

Such a belt-type continuously variable transmission comprises a primary shaft and a secondary shaft, which are two shafts mounted in parallel to each other, a drive side pulley mounted on the primary shaft, and a following side pulley mounted on the secondary shaft. The drive side and following side pulleys are each formed by combining a stationary sheave and a movable sheave opposed to the stationary sheave. Specifically, the stationary sheave is fixedly and integrally mounted on the outer circumference of a shaft, while the movable sheave is provided so as to approach and depart with respect to the stationary sheave in the axial direction.

A V-shaped groove is formed between the stationary sheave and the movable sheave of each pulley, and an endless belt is wound around the drive side pulley and the following side pulley, running in the respective V-grooves. A hydraulic chamber is provided to each pulley for generating a pressure to sandwich the belt by the respective sheaves.

In such a belt-type continuously variable transmission, the movable sheave of each pulley moves in the axial direction in response to independent control of the oil pressure in the respective hydraulic chamber, whereby the width of the V-groove of each pulley can be changed. With change of the V-groove, the belt winding position in the radial direction of each pulley; in other words, the winding radius of the belt of each pulley, is changed, whereby the transmission ratio of the belt-type continuously variable transmission can be continuously changed.

In some conventional belt-type continuously variable transmissions, the number of rotations of the drive side pulley and that of the following side pulley are counted, and the transmission ratio; that is, the winding position of the belt, is determined based on the ratio of the rotation numbers. However, the number of rotations of each pulley determined may contain a transmission loss in a driving force due to belt slip or the like with respect to each pulley, and therefore there is a problem that the actual speed ratio (a belt winding position) cannot be accurately determined.

Patent Document 1, mentioned below, discloses a continuously variable transmission comprising a pulley position sensor for determining the position of a drive movable pulley (corresponding to the movable sheave of the drive side pulley) and a control device for determining an actual transmission ratio based on the result of determination by the sensor, and controlling movement of the driving movable pulley in the axial direction such that the actual transmission ratio becomes equal to a target transmission ratio.

According to Patent Document 1, the pulley position sensor is provided in a direction in which the drive movable pulley moves away from the drive stationary pulley (corresponding to the stationary sheave of the drive side pulley). The pulley position sensor has a shaft that is movable in the axial direction, with the tip end of the shaft abutting the drive movable pulley. In such a pulley position sensor, change in a magnetic field generated in a circuit in the pulley position sensor is determined with the drive movable pulley moving in the axial direction and the shaft as well moving in the axial direction, whereby the position of the drive movable pulley can be determined.

### RELATED ART DOCUMENT

### Patent Document

Patent Document 1: Japanese Patent Laid-open Publication No. Hei 5-187532

### Problem to be Solved by the Invention

In the continuously variable transmission described in Patent Document 1 described above, an actual transmission ratio can be determined based on the position of the drive movable pulley. However, there is only a limited space for mounting a continuously variable transmission mounted on a vehicle, and moreover, there is a request for size reduction of a continuously variable transmission. Therefore, there is no room in a continuously variable transmission for ensuring a sufficient space for mounting a pulley position sensor such as that described in Patent Document 1. Specifically, a device for moving a movable sheave in the axial direction is already mounted in the direction in which the movable sheave moves away from the stationary sheave, and accordingly there is not sufficient space left for mounting a pulley position sensor such as that described in Patent Document 1.

An object of the present invention is to provide a belt-type continuously variable transmission having a simple structure and adapted to size reduction and capable of accurate determination of an actual transmission ratio.

### DISCLOSURE OF INVENTION

### Means to Solve the Problem

The present invention is characterized in providing a belt-type continuously variable transmission including a drive side pulley and a following side pulley each having a stationary sheave and a movable sheave opposed to the stationary sheave, and a belt wound around these pulleys for transmitting a driving force of the drive side pulley to the following side pulley, wherein the movable sheave is moved in the axial direction to thereby change the winding position of the belt in the radial direction of the drive side pulley and the following side pulley so that the transmission ratio is changed, the belt-type continuously variable transmission comprising a measurement surface formed on an outer circumferential end of the movable sheave; and a displacement sensor provided isolatedly from the outer circumferential end for measuring the distance between the measurement surface and the displacement sensor, wherein the measurement surface is formed such that the distance between the measurement surface and the displacement sensor is changed as the movable sheave moves in the axial direction.

The displacement sensor may be provided along the radial direction of the movable sheave, and the measurement surface may be formed inclined toward the same side relative to the axial direction.

The belt-type continuously variable transmission may further comprise

a case for accommodating the drive side pulley, the following side pulley, and the belt, and the displacement sensor may be placed in the case.

The measurement surface may be formed to have a length equal to the distance by which the movable sheave moves in the axial direction.

The belt-type continuously variable transmission may further comprise a belt position calculating unit for calculating the winding position of the belt in the radial direction of the drive side pulley and the following side pulley, based on a result of determination by the displacement sensor, and a transmission ratio calculating unit for calculating the transmission ratio, based on the winding position of the belt calculated by the belt position calculating unit.

The measurement surface may be formed on the outer circumferential end of the movable sheave of either one of the drive side pulley and the following side pulley.

The measurement surface may be formed such that the distance between the measurement surface and the axis becomes shorter toward the stationary sheave.

The displacement sensor may be of an eddy current type.

### ADVANTAGE OF THE INVENTION

According to a belt-type continuously variable transmission according to the present invention, it is possible, using a simple structure, to accommodate size reduction, and to accurately measure an actual transmission ratio.

### BRIEF DESCRIPTION OF DRAWINGS

FIG. 1 is a diagram showing a schematic structure of a vehicle according to an embodiment of the present invention;

FIG. 2 is a diagram showing a schematic structure of a drive side pulley and a surrounding area thereof of a belt-type continuously variable transmission according to the embodiment;

FIG. 3A is a diagram showing a condition with the minimum distance between a displacement sensor and a measurement surface, and FIG. 3B is a diagram showing a condition with the maximum distance between the displacement sensor and the measurement surface;

FIG. 4 is a diagram showing a relationship between displacement of a movable sheave and a value determined by the displacement sensor;

FIG. 5 is a diagram showing a relationship between a value determined by the displacement sensor and a belt winding position; and

FIG. 6 is a diagram showing a relationship between a belt winding position and a transmission ratio.

### BEST MODE FOR CARRYING OUT THE INVENTION

In the following, an embodiment of a belt-type continuously variable transmission according to the present invention will be described by reference to the drawings. In this embodiment, an automobile that is driven by an output from an engine will be referred to as an example, and a belt-type continuously variable transmission mounted in the automobile will be described. However, application of the present invention is not limited to a belt-type continuously variable transmission mounted in an automobile that is driven by an output from an engine, and the present invention can be applied to a belt-type continuously variable transmission mounted in an automobile that is driven by an output from a motor, such as, e.g., a hybrid vehicle or an electric vehicle.

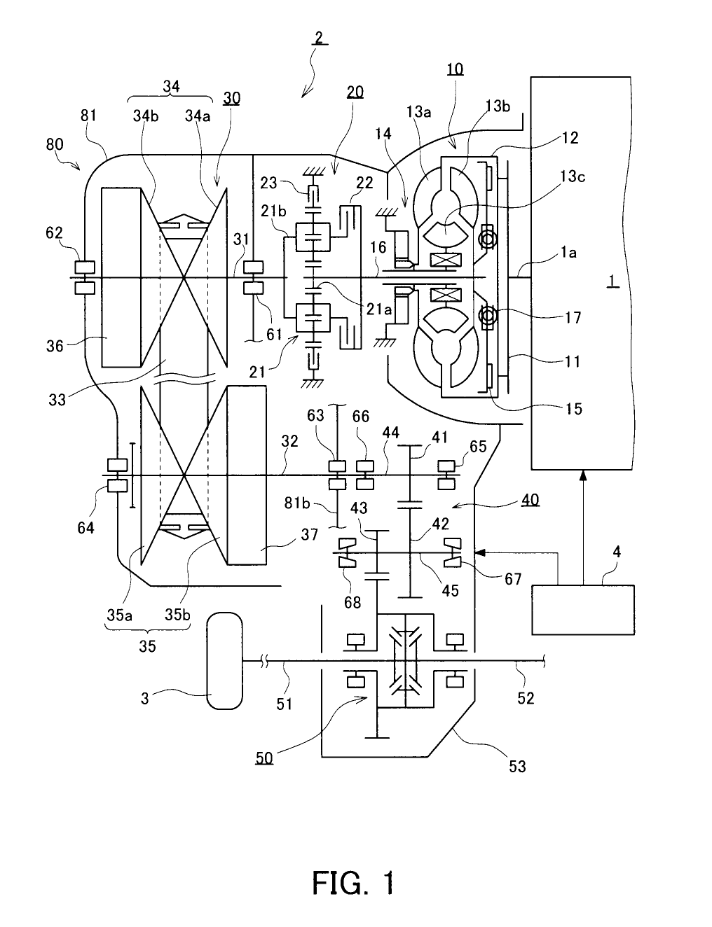

Initially, a schematic structure of a vehicle carrying a belt-type continuously variable transmission 30 will be described by reference to FIG. 1. A vehicle has an engine 1 serving as a motor. The engine 1 is connected to a wheel 3 via a driveline 2. The engine 1 and the driveline 2 are controlled by an engine control device (ECU) 4. A driving force produced by the engine 1 is transmitted to the wheel 3 via the driveline 2, whereby the vehicle runs.

The driveline 2 comprises a torque converter 10 serving as a clutch, a forward/reverse switching mechanism 20, a belt-type continuously variable transmission 30, a reduction mechanism 40, and a differential device 50. These structures will be briefly described below.

The torque converter 10 is connected to a crank shaft 1a, which is an output shaft of the engine 1. The torque converter 10 functions as a torque amplifier when the difference in the rotation speed between a pump impeller 13a and a turbine runner 13b is large, and as a fluid coupling when the difference in the rotation speed between the pump impeller 13a and the turbine runner 13b is small.

An operation of the torque converter 10 will be described. Along with the rotation of the crank shaft 1a, the pump impeller 13a rotates via a drive plate 11 and a front cover 12. Further, the turbine runner 13b starts rotating due to the flow of a hydraulic fluid supplied from an oil pump 14 as if being triggered by the pump impeller 13a. When the difference in the rotation speed between the pump impeller 13a and the turbine runner 13b is large, a stator 13c directs the flow of the hydraulic fluid into a direction which helps the pump impeller 13a rotate.

After the vehicle starts moving and when the vehicle speed reaches a predetermined speed, a lock-up clutch 15 starts operating. Thereupon, a driving force transmitted from the engine 1 to the front cover 12 is mechanically and directly transmitted to an input shaft 16. In the above, variation in the torque transmitted from the front cover 12 to the input shaft 16 is absorbed by a damper mechanism 17.

The forward/reverse switching mechanism 20 is connected via the input shaft 16 to the torque converter 10. The forward/reverse switching mechanism 20 comprises a double-pinion-type planetary gear mechanism 21, a forward clutch 22, and a reverse brake 23.

A sun gear 21a of the planetary gear mechanism 21 is connected to the input shaft 16, and a carrier 21b of the same is connected to a primary shaft (drive side shaft) 31 of the belt-type continuously variable transmission 30. By controlling the forward clutch 22 and the reverse brake 23, the driveline path is changed so that a forward rotation driving force (a positive rotational direction) and a rearward rotation driving force (a reverse rotational direction) can be switched.

The belt-type continuously variable transmission 30 is a device for continuously changing the rotation speed of the primary shaft 31, or an input shaft (a drive shaft), and transmitting force to a secondary shaft 32, or an output shaft (a driven shaft). The belt-type continuously variable transmission 30 comprises a primary pulley (a drive side pulley) 34 mounted on the primary shaft 31, a secondary pulley (a following side pulley) 35 mounted on the secondary shaft 32, and a belt 33 wound around these pulleys 34, 35 for transmitting a driving force of the primary pulley 34 to the secondary pulley 35. The belt 33 is formed endless, comprising many metallic pieces and a plurality of steel rings.

The primary shaft 31 and the secondary shaft 32 are made of metal, such as, e.g., iron. The primary shaft 31 is supported by a housing 80 of the driveline 2 via bearings 61, 62 so as to rotate and be substantially coaxial with the input shaft 16 of the torque converter 10. Meanwhile, the secondary shaft 32 is supported by the housing 80 via bearings 63, 64 so as to rotate and be in parallel with the primary shaft 31.

The primary pulley 34 is formed by combining a stationary sheave 34a and a movable sheave 34b opposed to the stationary sheave 34a. Specifically, the primary pulley 34 comprises the stationary sheave 34a formed integrally with the outer circumference of the primary shaft 31, and the movable sheave 34b mounted on the outer circumference of the primary shaft 31 so as to be opposed to the stationary sheave 34a and to move in the axial direction. The belt 33 is sandwiched by the stationary sheave 34a and the movable sheave 34b.

With a hydraulic actuator 36 driving the movable sheave 34b, the width of the V-groove between the sheaves 34a, 34b is changed. With the above, the winding position of the belt 33 in the radial direction of the primary pulley 34; in other words, the winding radius of the belt 33 of the primary pulley 34, is changed.

Meanwhile, the secondary pulley 35 is formed by combining a stationary sheave 35a and a movable sheave 35b opposed to the stationary sheave 35a. Specifically, the secondary pulley 35 comprises the stationary sheave 35a formed integrally with the outer circumference of the secondary shaft 32, and the movable sheave 35b mounted on the outer circumference of the secondary shaft 32 so as to be opposed to the stationary sheave 35a and to move in the axial direction. The belt 33 is sandwiched by the stationary sheave 35a and the movable sheave 35b.

With a hydraulic actuator 37 driving the movable sheave 35b, the width of the V-groove between the sheaves 35a, 35b is changed. With the above, the winding position of the belt 33 in the radial direction of the secondary pulley 35; in other words, the winding radius of the belt 33 of the secondary pulley 35, is changed.

As described above, in the belt-type continuously variable transmission 30, the movable sheaves 34b, 35b move approaching or departing with respect to the stationary sheaves 34a, 35a, respectively, to thereby adjust the width of the V-grooves of the respective pulleys 34, 35. With the adjustment, the winding position of the belt 33 in the radial direction of each pulley 34, 35 is changed, whereby the transmission ratio of the belt-type continuously variable transmission 30 can be changed. Note that a specific structure of the belt-type continuously variable transmission 30 in this embodiment will be described later.

The reduction mechanism 40 is connected via the secondary shaft 32 to the belt-type continuously variable transmission 30. The reduction mechanism 40 comprises two counter driven gears 41, 42 that are engaged with each other, and a final drive gear 43. The first counter driven gear 41 is fixedly mounted on a shaft connected to the secondary shaft 32 of the belt-type continuously variable transmission 30. The second counter driven gear 42 and the final drive gear 43 are fixedly mounted apart from each other on an intermediate shaft 45 placed substantially in parallel to the secondary shaft 32. The shaft 44 is supported so as to rotate, by the housing 80 via bearings 65, 66. The intermediate shaft 45 is supported so as to rotate, by the housing 80 via bearings 67, 68.

The differential device 50 is a device for dividing a rotating driving force transmitted from the reduction mechanism 40 at a desirable ratio and then transmitting the same to the wheels 3 connected to a pair of left and right axle shafts 51, 52. The differential device 50 is placed in a differential case 53.

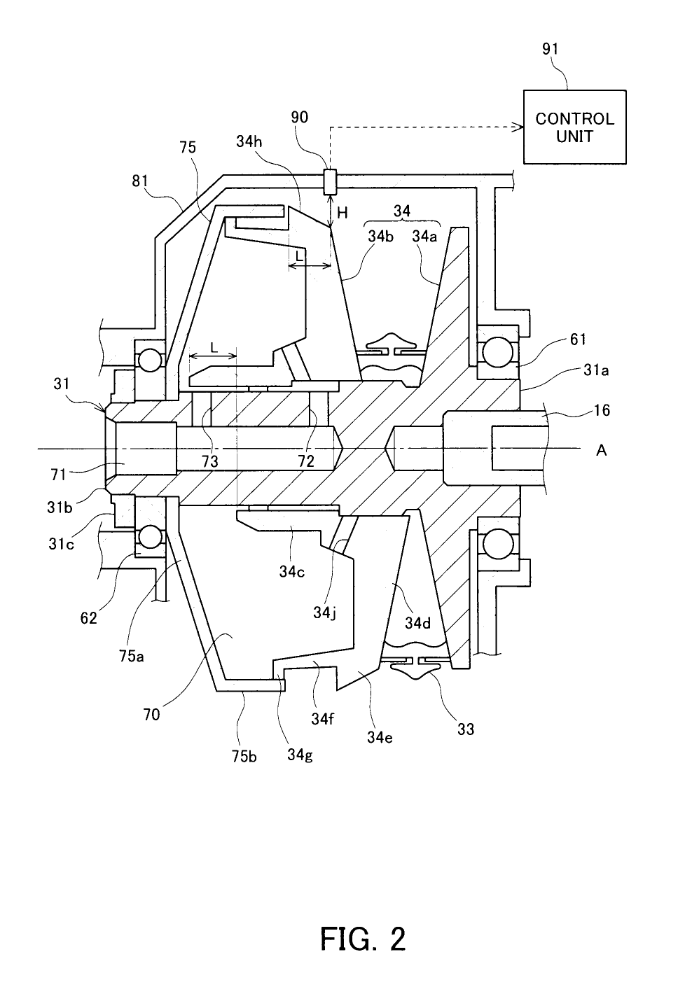

In the following, a specific structure of the belt-type continuously variable transmission 30 will be described by reference to FIG. 2. FIG. 2 is a diagram showing a specific structure of the primary pulley 34 and a surrounding area thereof. In the upper half of FIG. 2, a condition with a smaller winding radius of the belt 33 relative to the primary pulley 34 is shown, while in the lower half of the same, a condition with a larger winding radius of the belt 33 relative to the primary pulley 34 is shown. Note that a specific structure of the secondary pulley 35 and a surrounding area thereof is substantially identical to that of the primary pulley 34 and a surrounding area thereof and thus is not shown or described here.

Within a case 81 of the belt-type continuously variable transmission 30, the primary shaft 31, the primary pulley 34, and the belt 33 are accommodated. The case 81 is made of, e.g., metal such as aluminum alloy or the like. The case 81 is a part of the housing 80 of the driveline 2 in this embodiment, although the case 81 may be separated from the housing 80.

The input shaft 16 of the torque converter 10 is connected to an end of the primary shaft 31. Note that the end of the primary shaft 31 to which the input shaft 16 is connected will be hereinafter referred to as a tip end 31a, and the other end of the primary shaft 31 will be hereinafter referred to as a rear end 31b.

The primary shaft 31 is supported by the case 81 so as to rotate. Specifically, the tip end 31a of the primary shaft 31 is supported so as to rotate, by the case 81 via the bearing 61, while the rear end 31b of the same is supported so as to rotate, by the case 81 via the bearing 62.

On the primary shaft 31, the primary pulley 34 and a cylinder member 75 to be described later are mounted between the bearings 61 and 62. Specifically, from the tip end 31a of the primary shaft 31 to the rear end 31b, the stationary sheave 34a of the primary pulley 34, the movable sheave 34b of the same, and the cylinder member 75 are sequentially arranged. With this arrangement, the primary shaft 31, the primary pulley 34, and the cylinder member 75 can rotate relative to the case 81 with an axial line A serving as the center.

A locknut 31c is fastened on the rear end 31b of the primary shaft 31. With the locknut 31c fastened, the movable sheave 34b, the cylinder member 75, and the bearing 62 on the primary shaft 31 are integrally assembled.

Inside the primary shaft 31, an oil passage 71 extending in the axial direction is formed. The oil passage 71 is open on the end surface of the rear end 31b of the primary shaft 31, and is fed with hydraulic oil from a hydraulic circuit (not shown) via the hydraulic actuator 36. Oil passages 72, 73 extending in the radial direction of the primary shaft 31 and open on the outer circumferential surface of the primary shaft 31 join the oil passage 71.

The stationary sheave 34a is formed integrally with the outer circumference of the primary shaft 31, while the movable sheave 34b is formed capable of approaching and departing relative to the stationary sheave 34a. Specifically, the movable sheave 34b comprises a thick inside cylinder 34c, a radial direction portion 34d, and an outside cylinder 34f, wherein the radial direction portion 34d is formed continuously from an end of the inside cylinder 34c on the stationary sheave 34a side and defines a V-groove together by the stationary sheave 34a, and the outside cylinder 34f is formed extending from a position near an end 34e of the radial direction portion 34d on the outer circumferential side (hereinafter simply referred to as an outer circumferential end) in the axial direction toward the rear end 31b; that is, toward an outer circumferential portion 75b of the cylinder member 75. In addition, an annular projection 34g is formed on the end of the outside cylinder 34f, wherein an outer circumferential surface of the annular projection 34g abuts the inside circumferential surface of the outer circumferential portion 75b of the cylinder member 75. On the outer circumference of the annular projection 34g is provided a resin seal ring (not shown). Further, a through hole 34j is formed on the inside cylinder 34c, piercing therethrough in the radial direction and being open on the inner wall surface constituting a hydraulic chamber 70 to be described later.

A groove (not shown) extending in the axial direction is formed on the inner circumferential surface of the inside cylinder 34c of the movable sheave 34b, while a groove (not shown) extending in the axial direction is formed on the outer circumferential surface of the primary shaft 31. More specifically, these grooves include a plurality of grooves formed at a predetermined interval in the circumferential direction. The movable sheave 34b and the primary shaft 31 are positioned such that a groove on the movable sheave 34b side and that on the primary shaft 31 side have the same phase in the circumferential direction, and a plurality of balls (not shown) are placed overstriding both of the grooves. With the above, the movable sheave 34b is able to move smoothly in the axial direction relative to the primary shaft 31; in other words, to the stationary sheave 34a on the primary shaft 31, but cannot move relatively in the circumferential direction.

The cylinder member 75 is an annular member mounted between the movable sheave 34b and the bearing 62. The cylinder member 75 comprises a radial direction portion 75a and the cylindrical outer circumferential portion 75b, wherein the radial direction portion 75a is fit into the rear end 31b of the primary shaft 31 and extends outward in the radial direction, and the cylindrical outer circumferential portion 75b is connected to the radial direction portion 75a and abuts the annular projection 34g of the movable sheave 34b. The space enclosed by the movable sheave 34b and the cylinder member 75 constitutes the hydraulic chamber 70 for generating a pressure to sandwich the belt 33 by the sheaves 34a, 34b.

Oil pressure from the hydraulic actuator 36 is supplied to the hydraulic chamber 70 via the oil passage 71. More specifically, oil pressure from the hydraulic actuator 36 is supplied via the oil passage 73 and the through hole 34j in the condition shown in the upper half of FIG. 2, and via the oil passage 73 in the condition shown in the lower half of FIG. 2. The oil pressure force in the hydraulic chamber 70 acts on the movable sheave 34b toward the stationary sheave 34a side. With the oil pressure force in the hydraulic chamber 70 acting on the movable sheave 34b, the movable sheave 34b receives the pressure toward the stationary sheave 34a side, whereby a pressure to sandwich the belt 33 by the sheaves 34a, 34b is applied to the belt 33.

The position of the movable sheave 34b in the axial direction on the primary shaft 31 is determined according to the oil pressure in the hydraulic chamber 70, and when the oil pressure in the hydraulic chamber 70 is changed, the movable sheave 34b moves on the primary shaft 31 so as to approach or depart with respect to the stationary sheave 34b. Accordingly, the width of the V-groove between the sheaves 34a, 34b is changed. Specifically, increase of the oil pressure in the hydraulic chamber 70 causes the movable sheave 34b to move on the primary shaft 31 toward the tip end 31a side. Thereupon, the movable sheave 34b moves toward (closer to) the stationary sheave 34a, and the width of the V-groove becomes smaller and the winding radius of the belt 33 becomes larger, as shown in the lower half of FIG. 2. Meanwhile, decrease in the oil pressure inside the hydraulic chamber 70 causes the movable sheave 34b to move toward the rear end 31b on the primary shaft 31. Thereupon, the movable sheave 34b moves away (farther) from the stationary sheave 34a, and the width of the V-groove becomes larger and the winding radius of the belt 33 becomes smaller, as shown in the upper half of FIG. 2.

With the hydraulic actuator 36 controlling the oil pressure, as described above, the movable sheave 34b moves on the primary shaft 31 in the axial direction, whereby the width of the V-groove is changed. Similarly, although not shown in FIG. 2, with the hydraulic actuator 37 controlling the oil pressure, the movable sheave 35b moves on the secondary shaft 32 in the axial direction, whereby the width of the V-groove width is changed. The widths of the respective V-grooves formed in the primary pulley 34 and the secondary pulley 35 are controlled as being related to each other in accordance with the length of the belt 33 such that widening the V-groove width of either one of the pulleys leads to reduction of that of the other pulley. This enables transmission of a driving force of the primary pulley 34 to the secondary pulley 35 via the belt 33, while continuously changing the transmission ratio between the primary pulley 34 and the secondary pulley 35.

The belt-type continuously variable transmission 30 of this embodiment comprises a measurement surface 34h formed on the outer circumferential end 34e of the movable sheave 34b of the primary pulley 34, and a displacement sensor 90 provided isolatedly from the outer circumferential end 34e for measuring the distance H between the displacement sensor 90 and the measurement surface 34h. The measurement surface 34h is formed such that the distance H between the measurement surface 34h and the displacement sensor 90 is changed as the movable sheave 34b moves in the axial direction. In the following, a specific structure of the measurement surface 34h and the displacement sensor 90 will be described.

Specifically, the measurement surface 34h is formed on the outer circumferential surface of the outer circumferential end 34e. The measurement surface 34h is of length equal to or longer than the distance L by which the movable sheave 34d moves in the axial direction. This enables measurement of the distance H between the measurement surface 34h and the displacement sensor 90 within the range where the movable sheave 34d moves in the axial direction.

The measurement surface 34h is formed such that the distance therefrom to the axial line A becomes shorter towards the stationary sheave 34a side. With this arrangement, movement of the movable sheave 34b in the axial direction can change the distance H between the measurement surface 34h and the displacement sensor 90. Note that the cross sectional shape of the measurement surface 34h in the axial direction may present a straight line or a curved line. Note that although a case in which the distance between the measurement surface 34h and the axial line A becomes shorter as the measurement surface 34h moves toward the stationary sheave 34a is described in this embodiment, this structure is not limiting. For example, when the measurement surface 34h is formed inclined toward the same side relative to the axial direction, the measurement surface 34h may be formed such that the distance therefrom to the axial line A becomes shorter toward the cylinder member 75. With the above-described arrangement in which the measurement surface 34h is formed inclined toward the same side relative to the axial direction, it is possible, using a simple structure, to reliably change the distance H between the measurement surface 34h and the displacement sensor 90 as the movable sheave 34b moves in the axial direction.

The displacement sensor 90 is mounted on the case 81 along the radial direction of the movable sheave 34b. The displacement sensor 90 is a non-contact displacement sensor of, e.g., an eddy current type. That is, the displacement sensor 90 imparts a magnetic field on the measurement surface 34h and determines, using a coil (not shown) in the displacement sensor 90, change in impedance due to the eddy current caused on the measurement surface 34h, to thereby determine the distance H between the measurement surface 34h and the displacement sensor 90 that will change according to the movement of the movable sheave 34b in the axial direction. This structure makes it possible to ensure a space for mounting the displacement sensor 90 without enlarging the size of the case 81 even when a space for mounting the position sensor, in particular, a space in a direction in which the movable sheave moves away from the stationary sheave, cannot be ensured as described in the description on the related art. Note that although the displacement sensor 90 of an eddy current type is described in this embodiment, this structure is not limiting, and any non-contact displacement sensor, such as, e.g., a displacement sensor of a static capacitance type, an optical type, a supersonic type, and so forth, may be used. Nevertheless, a structure of a sensor of an eddy current-type displacement sensor is more compact than that of sensors of other types, and therefore can accommodate size reduction of the belt-type continuously variable transmission 30 and facilitate mounting of the sensor.

The belt-type continuously variable transmission 30 has a control unit 91 for controlling the primary shaft 36 to thereby change the transmission ratio. In one embodiment, the control unit 91 is realized through cooperation between hardware resources and software; specifically, e.g., an electronically controlled unit (ECU: Electronic Control Unit). Specifically, a function of the control unit 91 is realized by reading a control program recorded in a recording medium into a main memory, and executing the control program read by a CPU (Central Processing Unit). A control program may be provided as being recorded in a computer readable recording medium or through communication as a data signal. Note that the control unit 91 may be realized using hardware alone. The control unit 91 may be realized using one physical device or two or more physical devices.

The control unit 91 is connected to the displacement sensor 90. The control unit 91 comprises belt position calculating means (not shown) for calculating a winding position of the belt 33 in the radial direction of the primary pulley 34 and the secondary pulley 35, based on a result of determination by the displacement sensor 90, and transmission ratio calculating means (not shown) for calculating a transmission ratio based on the winding position of the belt 33 calculated by the belt position calculating means. The control unit 91 compares the transmission ratio (an actual transmission ratio) calculated by the transmission ratio calculating means and a transmission ratio (a requested transmission ratio) requested to the vehicle, and controls the hydraulic actuator 36 such that the actual transmission ratio becomes equal to the requested transmission ratio.

In the following, a relationship between the distance H and a transmission ratio will be described by reference to FIGS. 3 to 6.

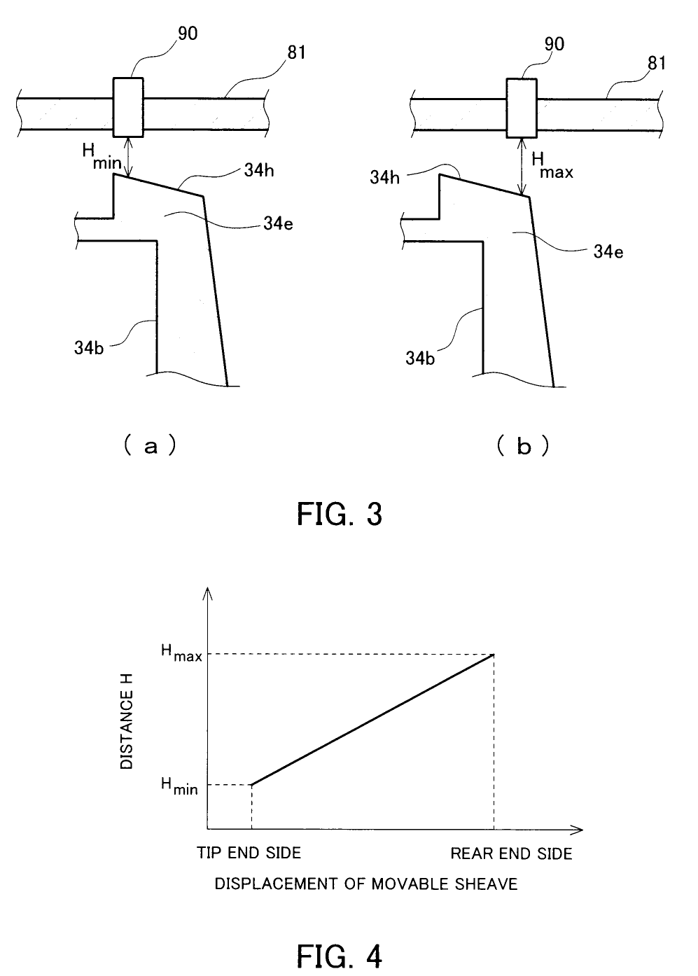

FIG. 3A shows the movable sheave 34b located closest to the tip end 31a side; that is, the stationary sheave 34a, within the movement range of the movable sheave 34b in the axial direction. In the above, the distance H between the displacement sensor 90 and the measurement surface 34h is minimized to be the distance Hmin. Meanwhile, FIG. 3B shows the movable sheave 34b located closest to the rear end 31b side; that is, farthest from the stationary sheave 34a, within the movement range of the movable sheave 34b in the axial direction. In the above, the distance H between the displacement sensor 90 and the measurement surface 34h is maximized to be the distance Hmax. As shown in FIG. 4, while the movable sheave 34b moves from the tip end 31a side to the rear end 31b side, the distance H gradually becomes longer from the minimum distance Hmin to the maximum distance Hmax.

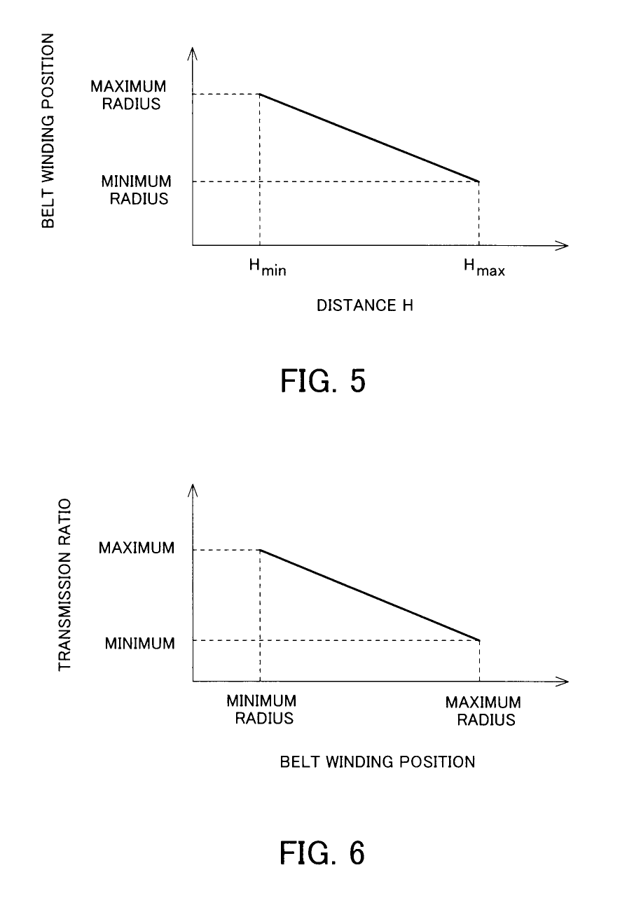

The belt position calculating means stores a map that collates a distance H determined by the displacement sensor 90 and a winding position of the belt 33. The map will be described by reference to FIG. 5. For the distance H being the minimum distance Hmin; that is, when the movable sheave 34b is located closest to the stationary sheave 34a, the width of the V-groove is minimized and the winding radius of the belt 33 is maximized. Meanwhile, for the distance H being the maximum distance Hmax; that is, when the movable sheave 34b is located farthest from the stationary sheave 34a, the width of the V-groove is maximized and the winding radius of the belt 33 is minimized. FIG. 5 shows that, as the distance H becomes larger, the winding position of the belt 33; that is, the winding radius, gradually becomes smaller. Use of a map prepared as described above enables the belt position calculating means to calculate the winding position of the belt 33, based on the distance H determined by the displacement sensor 90.

The transmission ratio calculating means stores a map that collates a winding position of the belt 33 calculated by the belt position calculating means and a transmission ratio. The map will be described by reference to FIG. 5. When the winding position of the belt 33, or the winding radius of the belt 33 in the primary pulley 34, is the minimum, the winding radius of the belt 33 in the secondary pulley 35 is maximized, and the transmission ratio is maximized. That is, the rotation speed is most reduced when a driving force is transmitted from the primary pulley 34 to the secondary pulley 35. Meanwhile, when the winding position of the belt 33, or the winding radius of the belt 33 in the primary pulley 34, is the maximum, the winding radius of the belt 33 in the secondary pulley 35 is minimized, and the transmission ratio is minimized. That is, the rotation speed is least reduced when a driving force is transmitted from the primary pulley 34 to the secondary pulley 35. FIG. 6 shows that as the winding position of the belt 33, or the winding radius, becomes larger, the transmission ratio gradually becomes smaller. Use of a map prepared as described above enables the transmission ratio calculating means to calculate a transmission ratio based on the winding position of the belt 33 calculated by the belt position calculating means.

According to the belt-type continuously variable transmission 30 in this embodiment, it is possible to accurately determine an actual transmission ratio merely by forming the measurement surface 34h on the outer circumferential end 34e of the movable sheave 34b and providing the displacement sensor 90 isolated relative to the outer circumferential end 34e; that is, without making significant change to the structure of a conventional belt-type continuously variable transmission. Moreover, the measurement surface 34h and the displacement sensor 90, which have a simple structure and do not require a large space to be mounted, can accommodate size reduction of the belt-type continuously variable transmission 30.

In this embodiment, there is described a case in which the displacement sensor 90 is provided isolatedly from the outer circumferential end 34e of the movable sheave 34b of the primary pulley 34 and the distance H between the displacement sensor 90 and the measurement surface 34h formed on the outer circumferential end 34e is measured, and the transmission ratio is determined. However, this structure is not limiting. Specifically, as the movable sheave 35b of the secondary pulley 35 moves along with movement of the movable pulley 34b of the primary pulley 34, it is possible to determine a transmission ratio by providing the displacement sensor 90 isolatedly from the outer circumferential end of the movable sheave 35b and measuring the distance H between the displacement sensor 90 and the measurement surface formed on the outer circumferential end of the movable sheave 35b.

### BRIEF DESCRIPTION OF REFERENCE NUMERALS

30 belt-type continuously variable transmission, 31 primary shaft, secondary shaft, 33 belt, 34 primary pulley, 34a, 35a stationary sheave, 34b, 35b movable sheave, 34e outer circumferential end 34h measurement surface, 35 secondary pulley, 81 case, 90 displacement sensor, 91 control unit.

1. A belt-type continuously variable transmission, including
a drive side pulley and a following side pulley each having a stationary sheave and a movable sheave opposed to the stationary sheave, and
a belt wound around these pulleys for transmitting a driving force of the drive side pulley to the following side pulley, wherein
the movable sheave is moved in an axial direction to thereby change a winding position of the belt in a radial direction of the drive side pulley and the following side pulley so that a transmission ratio is changed, the belt-type continuously variable transmission comprising:
a measurement surface formed on an outer circumferential end of the movable sheave; and
a displacement sensor provided isolatedly from the outer circumferential end along a radial direction of the movable sheave for measuring a distance between the measurement surface and the displacement sensor,
wherein
the measurement surface is formed inclined relative to the axial direction such that the distance between the measurement surface and the displacement sensor is changed as the movable sheave moves in the axial direction, and
the measurement surface is formed such that a distance between a predetermined position on the measurement surface and an axis becomes shorter as the predetermined position moves toward the stationary sheave side.

2. (canceled)

3. The belt-type continuously variable transmission according to claim 1, further comprising
a case for accommodating the drive side pulley, the following side pulley, and the belt,
wherein
the displacement sensor is placed in the case.

4. The belt-type continuously variable transmission according to claim 1, wherein the measurement surface is formed having a length equal to a distance by which the movable sheave moves in the axial direction.

5. The belt-type continuously variable transmission according to claim 1, further comprising:
belt position calculating means for calculating the winding position of the belt in the radial direction of the drive side pulley and the following side pulley, based on a result of determination by the displacement sensor, and
transmission ratio calculating means for calculating the transmission ratio, based on the winding position of the belt calculated by the belt position calculating means.

6. The belt-type continuously variable transmission according to claim 1, wherein the measurement surface is formed on the outer circumferential end of the movable sheave of either one of the drive side pulley and the following side pulley.

7. (canceled)

8. The belt-type continuously variable transmission according to claim 1, wherein the displacement sensor is of an eddy current type.
